(19) United States
(12) Patent Application Publication
(10) Pub. No.: US 2022/0017334 A1
(43) Pub. Date: Jan. 20, 2022

(54) DOOR CONTROLLER AND DOOR CONTROL SYSTEM FOR CONTROLLING MOVEMENTS OF AT LEAST ONE DOOR LEAF OF AN ELEVATOR DOOR

(71) Applicant: Inventio AG, Hergiswil (CH)

(72) Inventor: Hansueli Stocker, Immensee (CH)

(21) Appl. No.: 17/309,364

(22) PCT Filed: Dec. 13, 2019
(86) PCT No.: PCT/EP2019/085002

§ 371 Date: May 21, 2021

(30) Foreign Application Priority Data
Dec. 18, 2018 (EP) 18213526.9

(51) Int. Cl. B66B 13/26; E05F 15/40; E05F 15/70

(52) U.S. Cl. CPC B66B 13/26; E05F 15/40; E05Y 2900/104; E05Y 2400/40; E05Y 2400/54; E05F 15/70

(57) ABSTRACT

A door control system with a door controller controls shift movements of at least one door leaf of an elevator door. The door controller is configured as a slave controller to implement master instructions from an elevator controller, acting as a master controller, by actuating a door drive. The door controller is also configured to autonomously reverse a previous door leaf movement, preferably by a specified distance, when a collision of the at least one door leaf with an obstacle is detected, by appropriately actuating the door drive. In this way, even in the event of a malfunction of the elevator controller or if an elevator installation is operated in a fire mode or maintenance mode, it can be ensured that no obstacles or people are trapped in the elevator door.

### FIELD

The present invention relates to a door controller and to a door control system as well as to a method for controlling shift movements of at least one door leaf of an elevator door.

### BACKGROUND

An elevator door can close access to an elevator car of an elevator installation and, if necessary, be temporarily opened in order to allow access so that, for example, a passenger can enter the elevator car. For this purpose, the elevator door usually has one or more door leaves that can be shifted between an open position and a closed position. A shift movement of the door leaves is usually controlled by a door control system.

The door control system, in the form of a master-slave system, conventionally has a master controller that specifies the way in which the door leaves are to be shifted. For example, the master controller can specify the direction in which the door leaves are to be moved, how far the door leaves are to be moved and/or at what speed or with what time-speed profile the door leaves are to be moved. The master controller can typically be part of an elevator controller, by means of which the behavior of various components of the elevator installation is controlled. The master controller outputs, to a door controller, and by means of master instructions, the specifications for how the door leaves are to be shifted.

In this case, the door controller acts as a slave controller and is designed to control the actual movement of the door leaves in such a way that the master instructions are taken into account. To that end, the door controller controls, for example, a power supply to actuators or motors, by means of which the door leaves are shifted.

Regulations such as European standard EN81 can require that if a door leaf of an elevator door is shifted, it has to be detected if the door leaf collides with an obstacle. For example, it should be detected if a door leaf of a closing elevator door collides with a person in the travel path of the elevator door. It should also be detected if a door leaf of an opening elevator door is inhibited in its movement because, for example, a person's fingers are trapped between the opening door leaf and a door frame.

Furthermore, it may be required that a force with which a door leaf is shifted be limited, for example by a closing force limitation means being activated. The force can be limited to a maximum of 150 N, for example. In this way, in the event of a collision with a person, said person can be prevented from being trapped or even crushed.

In addition to collision detection and closing force limitation, it is generally also required that the elevator door be reversed in its direction of movement when a collision is detected, i.e., moved briefly counter to its previous direction of movement. In this way it can be ensured that a person who may have been trapped briefly in the collision is released again as quickly as possible.

In conventional elevator installations, a reversal of the direction of movement when a collision is detected is usually controlled by the elevator controller itself. To this end, the elevator controller outputs a master instruction by means of which the door controller is ordered to briefly move the elevator leaf of the door back, counter to its previous direction of movement.

In WO 81/01836 A1, options for reversing an elevator door movement are described.

However, it was recognized that a reversal of the direction of movement when a collision is detected in conventional door control systems in elevator installations does not function reliably and/or in a suitable manner in all cases.

### SUMMARY

There may therefore be a need, inter alia, for a door controller and a door control system, and for a method that can be carried out thereby and is intended for controlling shift movements of at least one door leaf of an elevator door, by means of which a reliable and/or suitable reversal of the direction of movement of a door leaf when a collision is detected can be ensured.

Such a need can be met by the subject matter according to the advantageous embodiments defined in the following description.

According to a first aspect of the invention, a door controller for controlling shift movements of at least one door leaf of an elevator door is proposed. The door controller is configured, in the form of a slave controller, to implement master instructions from an elevator controller, acting as a master controller, by actuating a door drive. The door controller is also configured to autonomously reverse a previous door leaf movement when a collision of the at least one door leaf with an obstacle is detected, by appropriately actuating the door drive.

According to a second aspect of the invention, a door control system for controlling shift movements of at least one door leaf of an elevator door is described. The door control system has a master controller as part of an elevator controller, which outputs master instructions that specify the manner in which the at least one door leaf is to be shifted. Furthermore, the door control system has a slave controller which is designed as a door controller according to one embodiment of the first aspect of the invention.

According to a third aspect of the invention, a method for controlling shift movements of at least one door leaf of an elevator door is described, a previous door leaf movement being reversed autonomously by a door controller, independently of an elevator controller acting as a master controller, when a collision of the at least one door leaf with an obstacle is detected, by appropriately actuating a door drive.

Possible features and advantages of embodiments of the invention can be considered, inter alia, and without limiting the invention, to be based on the concepts and findings described below.

As noted above, the reversal of a direction of movement of a door leaf of a closing or opening elevator door is usually controlled directly by the elevator controller. The elevator controller acts as a master controller and its master instruction, by means of which it orders the reversed shift of the door leaf, is implemented by a door controller acting as a slave controller, for example by actuators that cause the shift being suitably energized. The conventional task of the door controller is merely to implement the master instruction in a suitable manner, but it does not itself have any influence on the target specifications according to which the door leaf is to be shifted.

In this conventional procedure, however, at least in certain operating situations, the movement of the door leaf may be inadequately reversed.

For example, in the event that so-called first-order errors occur in the elevator installation, in the case of which, for example, the elevator controller no longer functions correctly or no longer communicates correctly with other components in the elevator installation, situations can arise in which the door leaf of the elevator door is not reversed in the desired manner despite a collision being detected. This can result in a risk of injury to people who have been trapped.

Furthermore, elevator installations typically have a fire control mode, i.e., a mode in which, for example, the fire department can move the elevator installation in the event of a fire. In this fire control mode, the components of the elevator installation are typically no longer controlled by the elevator controller but are controlled on a car operation panel (COP), for example as a result of operation of operating elements, which can be carried out directly by firefighters. In such a mode, however, there is also no possibility of reversing the door leaf of an elevator door in the event of a collision, in a manner controlled by the elevator controller. In this safety-relevant mode, configurations can therefore arise in which, for example, a firefighter collides with the elevator door and, in the worst case, is trapped by said door.

In order to overcome, in particular, the above-mentioned deficits of conventional door control systems in elevator installations, the door controller in such a door control system is specifically designed according to the invention such that, when a collision of a door leaf with an obstacle is detected, the door controller autonomously reverses the previous door leaf movement by the door controller itself appropriately actuating the door drive. In other words, the door controller is intended to be designed to independently prompt a brief reversal of the direction of movement of the door leaf if a collision is detected.

By way of example, the car operation panel can be provided with buttons or operating panels which, by means of operation, allow the elevator door to be opened or closed, in particular during the activated fire control mode. When the obstacle is encountered, a brief reversal, as explained above, of the direction of movement of the door leaf is made possible by means of the door controller, in particular without the influence of the elevator controller.

The door controller can in particular be configured to reverse the previous door leaf movement when the collision is detected, in a manner unaffected by instructions from the master control.

In other words, the door controller is intended to carry out or actuate the reversal of the door leaf movement regardless of what master instruction is currently being output by the elevator controller and received at the door controller.

In particular, the door controller is also intended to reverse the door leaf movement when a collision is detected if the elevator controller outputs a master instruction according to which a door leaf movement is to be stopped or continued, for example due to operation of corresponding operating elements on the car operation panel. In other words, the door controller is intended to remain unaffected by someone pressing a “stop” button or a “close door” button on the car operation panel, for example, and thereby causing a corresponding master instruction to be output. Instead, in the event that a collision is detected, the door controller is intended to cause the door leaf to reverse in any case.

As an exception to this general rule, so to speak, the door controller can be configured to reverse the previous door leaf movement when the collision is detected and when a master reversal instruction which specifies that the previous door leaf movement is to be reversed in a specified manner is received from the master controller, by appropriately actuating the door drive following the master reversal instruction.

In other words, in the event that a collision of a door leaf with an obstacle is detected and the master reversal instruction is received by the master controller simultaneously or shortly thereafter, instead of the normally autonomously actuated standard reversal of the previous door leaf movement, the door controller can cause a specific reversal of the door leaf movement, by means of which the manner in which the direction of movement of the door leaf is to be reversed as specified in the master reversal instruction is implemented.

In other words, the reversal of the door leaf movement caused by the door controller is generally not intended to be able to be influenced, in particular is not intended to be able to be prevented, by the elevator controller acting as the master controller.

As an exception to this, it is possible for the master controller not to be able to prevent reversal, but to be able to influence the way in which the door leaf movement is to be reversed by said master controller itself outputting the master reversal instruction and thus, for example, specifying how fast and/or for how long the door leaf is to be moved in the reversed direction of movement.

According to one embodiment, the door controller can be configured to reverse the previous door leaf movement by a specified distance when the collision is detected.

In other words, when the collision is detected, the door controller can allow the colliding door leaf to be moved back by a specified distance in a targeted manner. The fact that the door controller itself usually has position information is used to advantage here. Such position information includes information about where the door leaf is currently located and/or how quickly it is currently being moved. The door controller can use this position information to allow the door leaf to be reversed by the specified distance in a targeted manner. In other words, this means that the door controller has at least one item of position information about the door leaf and the master controller does not know this position information.

In contrast, such information is usually not available to the elevator controller, in the form of the master controller, in an up-to-date form. Instead, the master controller usually knows only that a corresponding master instruction has been transmitted to the door controller, but cannot specifically check to what extent the door controller is executing this master instruction. In particular, the master controller generally does not know where the door leaf is currently located and/or at what speed the door leaf is currently being shifted. The elevator controller or master controller usually controls a drive motor for shifting the elevator car along the main alignment of an elevator shaft belonging to the elevator installation.

In particular, the current speed of the door leaf shift can depend, for example, on different operating modes. In a normal operating mode, the door leaf is shifted at a standard speed. However, the shift speed of the door leaf can be greatly modified during maintenance or in the event of a fire. After a power failure and during subsequent recalibration, the door leaf can also be shifted much more slowly, for example. The elevator controller acting as the master controller either has no information about the current operating mode or at least does not use this information to control the reversal of the door leaf by means of the master instruction in accordance with the situation.

Accordingly, the master controller generally cannot specify the distance by which the door leaf is to be shifted during the reversal. Instead, the master controller generally only specifies a period of time during which the direction of movement of the door leaf movement is to be reversed as part of a reversal process. Depending on how fast the door leaf is moved, this specified period of time leads to a greater or smaller distance by which the door leaf is actually shifted back.

In particular in configurations in which the door leaf is shifted very slowly, i.e., as part of recalibration, for example, a collision of the door leaf with a person can result in the door leaf being reversed, following the master instruction, for a period that is too short in this case and thus insufficiently far, and the person continuing to be trapped.

Using the way presented here in which the door controller autonomously actuates the reversal of the door leaf movement by a specified distance, it can be ensured that in the event of a collision of the door leaf with an obstacle or a person, the door leaf is always shifted sufficiently far back to release the obstacle or person.

The specified distance can be shorter than 50 mm, for example, in particular between 10 mm and 30 mm.

It was recognized that a slight reversal of the door leaf movement by approximately 20 mm±10 mm can usually be sufficient, for example, to be able to sufficiently release a person trapped by the door leaf during the collision.

Alternatively, the slight reversal caused autonomously by the door controller can take place over a sufficiently short distance of less than 50 mm, preferably less than 30 mm, such that the shifting back of the door leaf that occurs generally does not negatively affect or stop subsequent operation of the elevator and in particular of the door control system.

According to one embodiment, the door controller can detect the collision on the basis of activation of a closing force limitation means.

In other words, the door controller can cooperate with a closing force limitation means and, via said means, detect if a door leaf has collided with an obstacle. The closing force limitation means has a sensor system that is activated when the collision occurs in order to be able to limit the force with which the door leaf pushes against the obstacle to a maximum of 150 N, for example. If the closing force limitation means has been activated, this can be detected by the door controller as a triggering event in order to then initiate the autonomous reversal of the door leaf movement.

It should be noted that some of the possible features and advantages of the invention are described herein with reference to various embodiments of the door controller or the door control system and of a method for controlling the shift movements of a door leaf of an elevator door. A person skilled in the art will recognize that the features can be suitably combined, adapted or replaced in order to arrive at further embodiments of the invention.

Embodiments of the invention will be described below with reference to the accompanying drawing, with neither the drawing nor the description being intended to be interpreted as limiting the invention.

### DESCRIPTION OF THE DRAWINGS

FIG. 1 shows a door control system according to one embodiment of the present invention.

The FIGURE is merely schematic and is not to scale.

### DETAILED DESCRIPTION

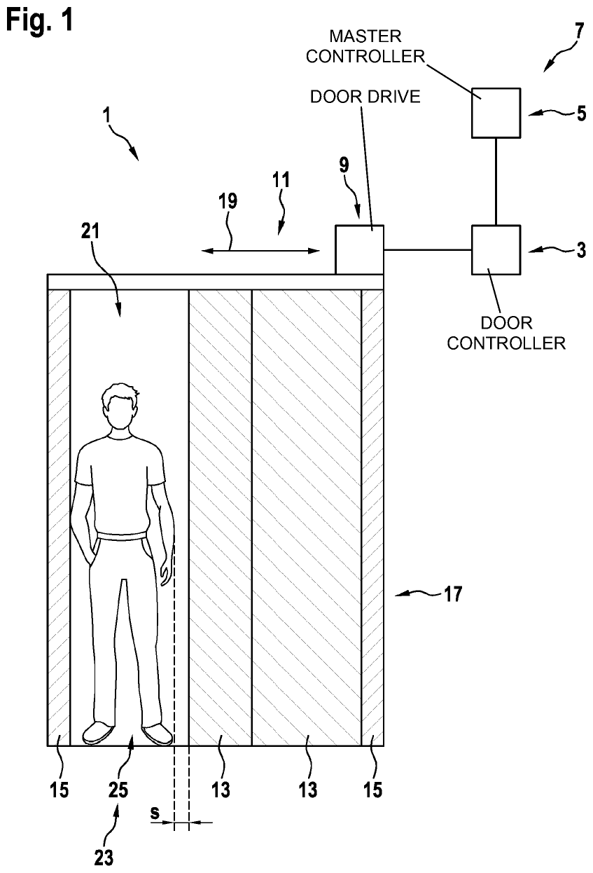

FIG. 1 shows a door control system 1 according to one embodiment of the invention. The door control system 1 comprises a door controller 3 and a master controller 5 which is designed as part of an elevator controller 7. The door controller 3 controls a door drive 9 of an elevator door 11. In the example shown, the elevator door 11 comprises two door leaves 13 which can be shifted laterally relative to a stationary frame 15 of an elevator car 17 along a travel path 19 by means of the door drive. As a result, access 21 to the interior of the elevator car 17 can be opened or closed as required.

In order to comply with regulations such as EN81, it has to be ensured that in the event that one of the door leaves 13, while being shifted along the travel path 19, collides with a person 25 acting as an obstacle 23, no excessive forces are exerted on the person 25 and, in particular, the person 25 is not trapped by the elevator door. Any person 25 who may be briefly trapped by the elevator door must be released again immediately.

It should be taken into account here that the door leaves 13 have a certain inertia during the shift, so that even if the elevator door 11 is stopped by a door closing force limitation means, the person 25 is initially still trapped before the door leaf 13 is reversed and thus opened again.

In addition, the previously typically vertically hanging door leaves 13 are usually tilted slightly due to the mechanical resistance of the obstacle 23.

In conventional elevator installations, the door control system is usually implemented in such a way that the elevator controller 7, in the form of the master controller 5, has monitored whether a door leaf 13 collides with an obstacle 23 and has controlled a reversal of the door leaf movement in the event of such a collision.

In the event of a failure of the elevator controller 7 or, for example, in the event that the elevator installation is operated in a specific fire mode during a fire, in which mode the components of the elevator installation are no longer controlled by the elevator controller 7, situations can arise in which obstacles 23 and in particular people 25 collide with door leaves 13 of the elevator door 11 and become trapped.

In order to avoid such situations, in the door control system 1 proposed herein, the door controller 3 is specifically configured for an autonomous and automated slight reversal of the door leaf movement in the event of a collision.

Specifically, the door controller 3 can detect a collision with an obstacle 23 on the basis of activation of a closing force limitation means, as has to be provided as standard on elevator doors.

In conventional elevator installations, the door controller 3 initially remains inactive in such a collision and a reversal of the door leaf movement is initiated only if this is prompted by the higher-level master controller by outputting a corresponding master instruction.

In contrast, the door controller 3 proposed herein is intended to autonomously prompt such a reversal of the door leaf movement by actuating the door drive 9 independently of instructions from the master controller 5, in such a way that the door leaves 13 are retracted counter to their previous door leaf movement.

A trapped person 25 or a trapped obstacle 23 is thus released automatically and quickly. The person 25 or the obstacle 23 is released independently of a function or any current malfunction of the elevator controller 7 and also independently of the current operating mode of the elevator installation, i.e., also during a fire mode or a maintenance mode.

In particular, the door controller 3 controls the drive 9 in the event of a collision in such a way that the colliding door leaf 13 is reversed by a specified distance s of, for example, approximately 20 mm. The distance s by which the door controller 3 moves the colliding door leaf 13 back can be independent of the current speed at which the door leaf 13 is shifted, and thus independent of the time required to shift the door leaf 13 by this distance s.

The door leaf 13 is reversed in a manner unaffected by any master instructions by the master controller 5, in particular independently of master instructions which specify that the door leaf movement is to be stopped or continued.

At most, the reversal of the door leaf 13 caused autonomously by the door controller 3 can be “overwritten” by a master reversal instruction by means of which the master controller 5 orders the door leaf 13 to be reversed, and thus specifies a specific way in which the door leaf 13 is to be reversed.

Finally, it should be noted that terms such as “have,” “comprising,” etc. do not exclude any other elements or steps, and terms such as “an” or “a” do not exclude a plurality. It should also be noted that features or steps that have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

10. A door controller for controlling shift movements of at least one door leaf of an elevator door, the door controller comprising:
a slave controller implementing master instructions received from an elevator controller acting as a master controller to actuate a door drive to shift the at least one door leaf of the elevator door, wherein the elevator controller controls an elevator car that includes the elevator door; and
wherein the door controller is adapted to autonomously reverse a previous door leaf movement of the at least one door leaf by actuating the door drive in response to a detection of a collision of the at least one door leaf with an obstacle.

11. The door controller according to claim 10 wherein the door controller reverses the previous door leaf movement, when the collision is detected, unaffected by the master instructions from the master controller.

12. The door controller according to claim 10 wherein the door controller reverses the previous door leaf movement, when the collision is detected and when a master reversal instruction that specifies that the previous door leaf movement is to be reversed in a specified manner is received from the master controller, by actuating the door drive following the receipt of the master reversal instruction.

13. The door controller according to claim 10 wherein the door controller reverses the previous door leaf movement by a specified distance when the collision is detected.

14. The door controller according to claim 13 wherein the specified distance is shorter than 50 mm.

15. The door controller according to claim 13 wherein the specified distance is between 10 mm and 30 mm.

16. The door controller according to claim 10 wherein the door controller detects the collision based upon activation of a closing force limitation means.

17. A door control system for controlling shift movements of at least one door leaf of an elevator door, the door control system comprising:
a master controller included in an elevator controller, the master controller outputting master instructions that specify a manner in which the at least one door leaf is to be shifted; and
a slave controller operating as a door controller according to claim 10.

18. An elevator installation comprising:
an elevator car having an elevator door with at least one door leaf;
a door drive for shifting the at least one door leaf;
an elevator controller acting as a master controller to actuate the door drive to shift the at least one door leaf of the elevator door, wherein the elevator controller controls shifting the elevator car in an elevator shaft; and
the door controller according to claim 10.

19. A method for controlling shift movements of at least one door leaf of an elevator door, the method comprising the steps of:
operating a door controller to actuate a door drive to shift the at least one door leaf in door leaf movements wherein the door controller acts a slave controller implementing master instructions from an elevator controller acting as a master controller of the door leaf movements; and
operating the door controller to autonomously reverse a preceding one of the door leaf movements independently of the elevator controller when a collision of the at least one door leaf with an obstacle is detected.
